(19) United States
(12) Patent Application Publication
(10) Pub. No.: US 2026/0363367 A1
(43) Pub. Date: Nov. 19, 2026

(54) GARMENT ADJUSTMENT SYSTEM

(71) Applicant: RFD BEAUFORT LIMITED, Ellesmere Port (GB)

(72) Inventors: Paul OLIVER, Rhyl (GB); Stefano CIPRIANI, Warrington (GB)

(21) Appl. No.: 19/126,248

(22) PCT Filed: Oct. 30, 2023
(86) PCT No.: PCT/EP2023/080238

§ 371 Date: Apr. 30, 2025

(30) Foreign Application Priority Data
Nov. 1, 2022 (GB) 2216201.0

(51) Int. Cl. A41D 13/02; B64D 10/00; F41H 1/02

(52) U.S. Cl. CPC A41D 13/02; B64D 10/00; F41H 1/02; A41D 2400/38

(57) ABSTRACT

A garment adjustment system is disclosed for adjusting the fit of a garment to a wearer, the system including a lacing arrangement (38) for attachment to the garment and a reel assembly (60), the reel assembly and the lacing arrangement being configured to cooperate to adjust the fit of the garment to the wearer.

### TECHNICAL FIELD

The invention relates to a garment adjustment system for adjusting the fit of a garment to a wearer, and to a garment including such a garment adjustment system.

### BACKGROUND TO THE INVENTION

Aircrew such as pilots wear an ensemble including a protective suit when flying in aircraft. Traditionally the suit is either a single piece suit combining both jacket and trousers in a single garment or it is a two-piece suit with a separate jacket and trousers.

The ensemble may include also special equipment (aircrew life support equipment—ALSE) that protects the wearer against the effects of high G-acceleration or altitude and other potentially damaging factors. Such equipment may include inflatable bladders. Lacings are provided to allow the suit to be correctly fitted to the particular wearer.

In use, an aircrew member such as a pilot dons the protective suit. The lacings are tightened so that the protective suit is a close fit around the torso and the lower body of the wearer so that, when inflated, the bladders apply a required restriction. Conventionally, the adjustment of the lacings cannot be performed by aircrew as the adjustment is difficult to perform. The adjustment is performed by a fitter (rather than the wearer) prior to the aircrew entering the aircraft. This can be inconvenient and result is a sub-optimal fit that is not tailored to the aircrew posture in the aircraft. Further, it is difficult for the aircrew to loosen the suit—for example in an emergency when evacuating the aircraft, which can impede movement of the aircrew and be detrimental to safety.

### SUMMARY OF THE INVENTION

According to one aspect of the invention, there is provided a garment adjustment system for adjusting the fit of a garment to a wearer, the system including a lacing arrangement for attachment to the garment and a reel assembly, the reel assembly and the lacing arrangement being configured to cooperate to adjust the fit of the garment to the wearer.

In an embodiment the system is configured to adjust the fit of the garment to the torso of the wearer.

In an embodiment the system is configured to adjust the fit of the garment to the legs of the wearer.

Garment adjustment systems may be provided to adjust both the fit of the garment to the torso of the wearer and to the legs of the wearer.

In an embodiment the reel assembly includes ratchet means for allowing the progressive tightening of the fit of the garment to the wearer. The ratchet means may comprise a pawl and tooth arrangement.

In an embodiment the reel assembly includes a release arrangement for releasing the ratchet means to loosen the fit of the garment. The release arrangement may include a grip member such that manual pulling of the grip member allows the lacing arrangement to loosen the fit of the garment. The grip member may comprise a flexible strip of material or webbing.

In an embodiment the lacing arrangement includes a cord, rope or lace, or the like.

The reel assembly may be motorised to automatically adjust the fit of a garment to the wearer.

According to a further aspect of the invention, there is provided a garment including the garment adjustment system mentioned above.

The garment may include a mounting for an armour member to protect the wearer, the garment adjustment system being configured to adjust the fit of the garment to the wearer to be appropriate when the armour member is present in the mounting and absent from the mounting.

According to another aspect of the invention, there is provided a garment including a garment adjustment system for adjusting the fit of a garment to a wearer, the system including a lacing arrangement attached to the garment and a reel assembly, the reel assembly and the lacing arrangement being configured to cooperate to adjust the fit of the garment to the wearer, wherein the garment includes a mounting for a removable armour member to protect the wearer, the garment adjustment system being configured to adjust the fit of the garment to the wearer to be appropriate when the armour member is present in the mounting and absent from the mounting.

By enabling adjustment of the fit of the garment to the wearer to be appropriate when the armour member is present in the mounting and absent from the mounting, this allows the armour member to be firmly and properly located on the body of the wearer so that vital organs are correctly protected as the armour member cannot shift its position. When the armour member is removed from the garment, the fit can be adjusted (tightened) to compensate for the absence of the armour member-so the garment still fits the wearer closely, e.g. to provide G protection.

The lacing arrangement may be attached to the garment such that the reel assembly and the lacing arrangement are configured to adjust the fit of the garment to the waist and chest of the wearer simultaneously. To facilitate this, the lacing arrangement may pass around a waist region of the garment, passes over a chest region of the garment and around a back portion of the garment.

The garment may include a plurality of the garment adjustment systems.

The garment may be an aircrew protection garment, for example. The garment may be any other type of garment.

The garment adjustment system for adjusting the fit of a garment may conveniently be adjusted by the wearer themselves. This may allow the wearer to board an aircraft with the garment untightened for ease of movement. When seated, the wearer can then tighten the garment to provide an optimum fit for their seated position. The anti G protection systems of the garment can therefore work in an optimised manner. The garment adjustment system may also be released quickly and conveniently by the wearer-so that they can move easily in an emergency, e.g. when evacuating an aircraft in an emergency or after ejection from the aircraft.

The garment adjustment system has been designed as an adjustment system to alter the size of garments-for example for the side adjustment on a flight jacket and the leg adjustment on G-trousers. There may be two garment adjustment systems per garment, one on the left which rotates anticlockwise, and one on the right which rotates clockwise, to pull a length of lace or cord in that is laced to the garment. The garment adjustment system may include four components per assembly which are as follows: lid, reel, main body and base. The reel and body may have two variations one which turns left/anti-clockwise and one which turns right/clockwise to perform tightening of the lace or cord.

In the embodiment to be described, the lid provides a surface to grip for the user to turn the product and wind the lace/cord up to perform tightening. The lid connects to the reel with (e.g.) two inserts that protrude out from the lid fitting into two slots on the reel. The reel has (e.g.) two arms with teeth on them that connect to the cut-out teeth on the main body forming a ratchet system that only allows the reel to turn one way when the arms engage with the body. The reel pivots around a rod that protrudes up from the main body. Below this rod there is a cut-out that the reel snaps into with the corresponding shape that is connected to the reel fitting into the cut out on the body. When this is locked in place the reel can only turn one way, winding the cord up. When the cord is to be loosened the reel is pulled out from the snap fit disengaging the ratchet system. The main body has wedges on the outside of it near to bottom which turn into slots on the base. A small dimple is located on the bottom of the body which aligns with a hole on the base locking the whole system into the base and preventing it from turning loose. The base is sewn into (or otherwise attached to) the garment with the body sticking through an aperture for the user to be able to access with ease.

### BRIEF DESCRIPTION OF THE DRAWINGS

For a better understanding of the present invention embodiments will now be described by way of example, with reference to the accompanying drawings, in which:

FIG. 1 is a general view of an aircrew ensemble including a chest counter-pressure assembly and full cover lower G assembly,

FIG. 2 is a perspective view of a garment adjustment system,

FIG. 3 is a top view of the garment adjustment system,

FIG. 4 is a perspective view of a lid of the garment adjustment system,

FIG. 5 is a cross-sectional view of the lid of the garment adjustment system,

FIG. 6 is a bottom view of the lid of the garment adjustment system,

FIG. 7 is a perspective view of a reel of the garment adjustment system,

FIG. 8 is a cross-sectional view of the reel of the garment adjustment system,

FIG. 9 is a bottom view of the reel of the garment adjustment system,

FIG. 10 is a perspective view of a main body of the garment adjustment system,

FIG. 11 is a cross-sectional view of the main body of the garment adjustment system, adjustment system,

FIG. 13 is a perspective view of a base of the garment adjustment system,

FIG. 14 is a cross-sectional view of the base of the garment adjustment system,

FIG. 15 is a cross-sectional view of the assembled garment adjustment system,

FIG. 16 is a perspective view of the reel mounted in the main body, showing the ratchet mechanism engaged,

FIG. 17 is a partial view of the garment adjustment system attached to the aircrew ensemble,

FIG. 18 is a partial view of the garment adjustment system ready to be attached to the aircrew ensemble,

FIG. 19 is view of a reinforced region of the aircrew ensemble to which the garment adjustment system is to be attached,

FIG. 20 is a side view of an upper suit portion and garment adjustment system,

FIG. 21 is a partial view of the upper suit portion and garment adjustment system of FIG. 20 in a loosened state,

FIG. 22 is a partial view of the upper suit portion and garment adjustment system of FIG. 20 in a tightened state,

FIG. 23 is a front view of an upper suit portion to which to garment adjustment systems are attached,

FIG. 24 is a front view corresponding to the arrangement of FIG. 23 and showing the path of the lace within the upper suit portion,

FIG. 25 is a rear view corresponding to the arrangement of FIG. 23 and showing the path of the lace within the upper suit portion,

FIG. 26 is a left side view corresponding to the arrangement of FIG. 23 and showing the path of the lace within the upper suit portion, and

FIG. 27 an enlarged view corresponding to the arrangement of FIG. 23 and showing the path of the lace within the upper suit portion where a garment adjustment system is attached.

In the drawings, like elements are generally designated with the same reference signs.

### DETAILED DESCRIPTION OF EMBODIMENT OF THE INVENTION

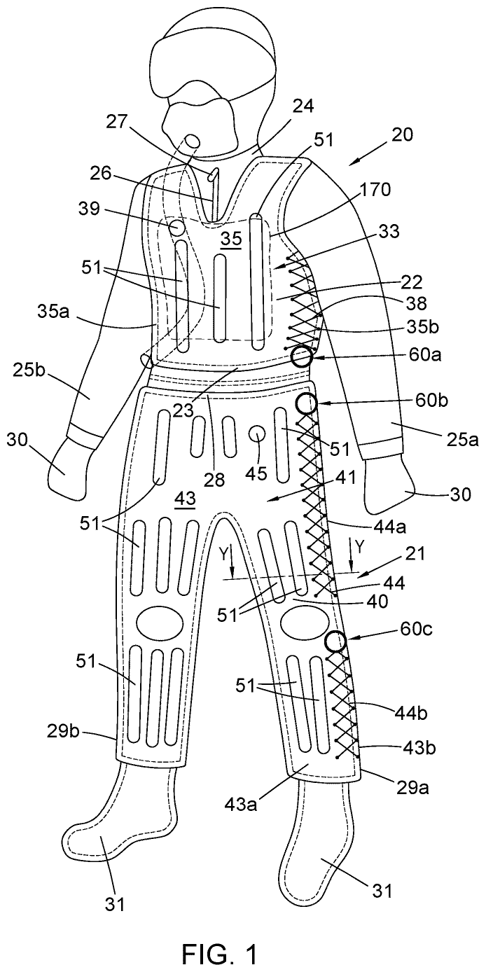

Referring first to FIG. 1, the aircrew ensemble includes a flight suit that comprises an upper suit portion 20 and lower suit portion 21. The upper suit portion 20 and the lower suit portion 21 are preferably made from an inherently fireproof fabric such as NOMEX®. The upper suit portion 20 has a torso portion 22, a waist 23, a neck opening 24 and left and right arm portions 25a, 25b, respectively. The upper suit portion also has a front opening 26 closed by, for example, a zipper 27. The lower suit portion 21 has a waist 28 and left and right leg portions 29a, 29b. The suit may also include gloves 30 and boots 31.

The upper portion 20 and the lower portion 21 may be formed in one-piece with a front central longitudinal zip or may be formed as separate parts and connected at the waist.

The upper portion 20 may carry a chest counter pressure assembly in the form of a jacket containing a chest counter pressure bladder 33. The upper portion 20 is formed of a connected outer layer 35 and inner layer (not shown) of air permeable material that hold the bladder 33 between them located on the chest of a wearer. The inner layer and/or the outer layer 35 of the upper portion 20 may be elastically deformable. The inner layer and/or the outer layer 35 of the upper portion 20 may be inelastic and/or inextensible. Preferably at least the outer layer 35 of the upper portion 20 is inelastic and/or inextensible.

The outer layer 35 is formed by front and rear portions 35a, 35b that are interconnected by a row of upper portion side lacing 38 (formed e.g. by one or more cords of ropes) located at the left side of the outer layer 35 to allow the circumferential length of the jacket to be adjusted to the correct fit for a wearer. This adjustment is important so that the bladder 33 can effectively provide counter pressure to the chest to counteract the effect of breathing pressurised gas when at altitude. If the garment is incorrectly fitted for the particular wearer the effectiveness of the bladder 33 to protect the wearer will be diminished.

The bladder 33 may be formed of an air-permeable material that allows air to pass through the material. The entire surface of the bladder 33 may be air permeable, or only part of the surface of the bladder 33 may be air permeable. The bladder 33 has an inlet 39 for connection to an inflation hose that, in turn, is connected to an inflation system for supplying air under pressure to the bladder 33. The inflation system may be part of a breathing system for the wearer. Both the inflation system and the breathing system may be part of the aircraft's pressurisation system.

The lower portion 21 carries a lower G assembly 40 assembly a lower G bladder 41. The lower G assembly 40 is formed by an outer layer 43 and an inner layer (not shown) of air-permeable material that hold the lower bladder 41 between them and located around the legs of a wearer and over the abdomen of the wearer. The inner layer and/or the outer layer 43 of lower G assembly 40 may be elastically deformable. The inner layer and/or the outer layer 43 of lower G assembly 40 may be inelastic and/or inextensible. Preferably at least the outer layer 43 of lower G assembly is inelastic and/or inextensible.

The outer layer 43 is formed by front and rear portions 43a, 43b with a side opening whose edges are interconnected by a row of lower portion side lacing 44 (formed e.g. by one or more cords of ropes) located to allow the circumferential length of the lower G assembly 40 outer layer 43 to be adjusted to the correct fit for a wearer. The lower portion side lacing 44 on each side may be comprise an upper side lacing section 44a and a lower side lacing section 44b. This adjustment is important so that the bladder 41 can effectively provide counter pressure to the legs when the wearer is being accelerated to reduce the effect of blood pooling in the lower limbs.

The bladder 41 may be formed of air-permeable material that allows air to pass through the material. The entire surface of the bladder 41 may be air permeable, or only part of the surface of the bladder 41 may be air permeable. The bladder 41 has an inlet 45 for connection to an inflation hose that, in turn, is connected to an inflation system for supplying air under pressure to the bladder 41. The inflation system may be part of the breathing system for the wearer.

In use, an aircrew member such as a pilot dons the suit with the upper portion 20 and lower portion 21. The lacings 38 and 44 are tightened to ensure that the upper portion 20 and the lower portion 21 are a close fit around the torso and the lower body portion respectively of the wearer so that, when inflated, the bladders 33, 41 apply a required restriction.

Whilst in flight, the chest bladder 33 and the lower G bladder 41 are pressurised and depressurised through the aircraft's pressurisation system. This happens as the aircraft experiences high G.

The chest bladder 33 and the lower G bladder 41 may be provided with elongate slots 51 to form “grill” bladders 33, 41. The slots 51 allow air movement through the slots 51 when the bladder 33, 41 is deflated and therefore evaporative cooling of sweat is assisted when uninflated. When the bladder 33 is uninflated, evaporative cooling can take place through the slots 51. The “grill” bladders 33, 41 (“fingers”) are formed of air-permeable material to provide cooling.

However, when inflated, the bladder 33, 41 expands laterally and outwardly to provide the continuous counter-pressure needed.

The bladder 33, 41 has an uninflated area and is formed, inwardly of the periphery of that area, with one or more open gaps that allow air movement through the gap or gaps to increase evaporative cooling. The or each gap closes or substantially closes on inflation of the bladder 33, 41.

The upper portion 20 side lacing 38 and the upper side lacing section 44a and a lower side lacing section 44b of the lower portion 21 may each be adjusted by a garment adjustment system 60. A separate garment adjustment system 60 may be provided for the upper portion 20 side lacing 38 (garment adjustment system 60a in FIG. 1) for adjusting the tightness of the upper portion 20 at the waist and chest, for the lower portion 21 upper side lacing section 44a (garment adjustment system 60b in FIG. 1) for adjusting the tightness of the lower portion 21 at the waist and thigh, and for the lower portion 21 lower side lacing section 44b (garment adjustment system 60c in FIG. 1) for adjusting the tightness of the lower portion 21 at the calf.

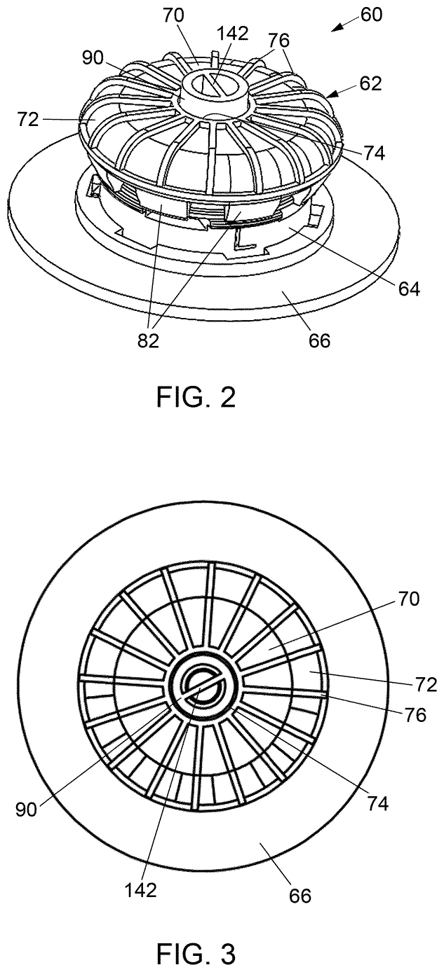

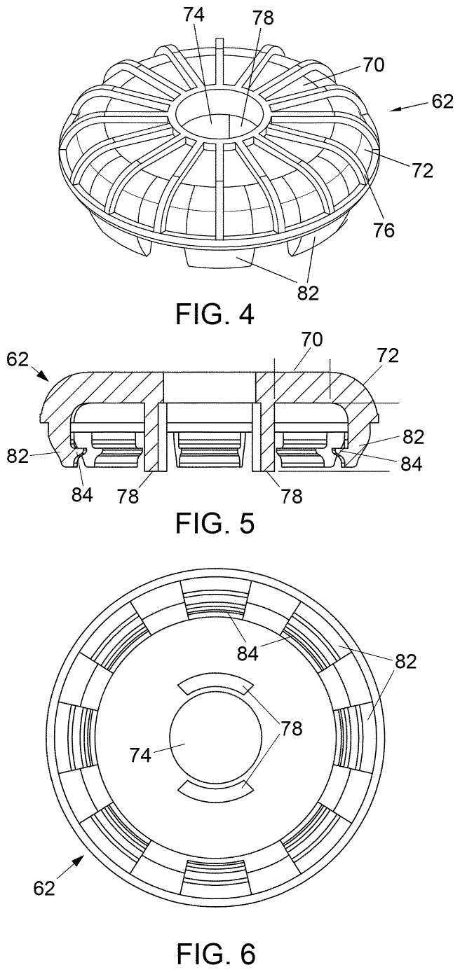

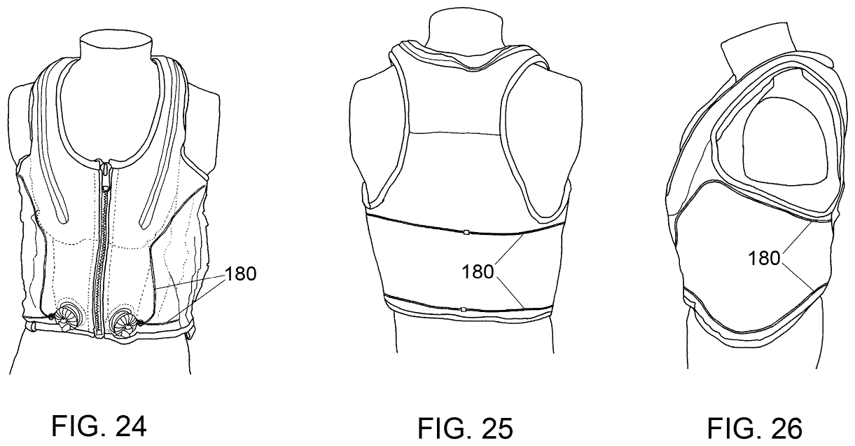

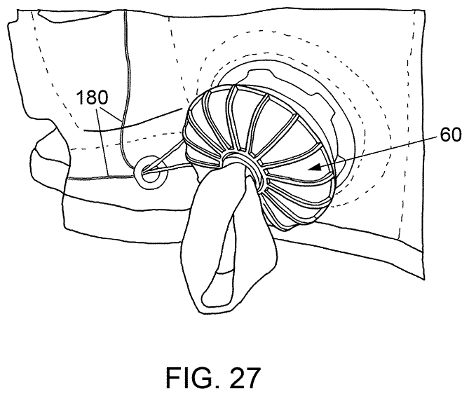

As will now be described with reference to FIGS. 2 to 27, the garment adjustment system 60 includes a lid 62, a main body 64, a base 66 and a reel 68.

The garment adjustment system 60 has an engaged mode and a disengaged mode. In the engaged mode the lid 62 is turned by a user in a tightening direction to wind the lacing cord up within the garment adjustment system 60. In the engaged mode the lid 62 cannot be turned in the opposite direction and so the lacing cord cannot unwind. In the disengaged mode the lacing cord is free to unwind from the garment adjustment system 60.

The lid 62 comprises a generally disc shaped upper section 70 from which a circumferential curved sidewall 72 extends. A circular aperture 74 is provided in the upper section 70. A plurality of radial ridges 76 may be formed on the upper surface of the lid 61 that extend radially from the aperture 74 to the distal end of the sidewall 72, which may help a user grip the lid 62 and/or reinforce the lid 62.

The lid 62 has (e.g.) two curved protruding inner walls 78 extending downwardly from the lower surface of the lid 62, generally perpendicularly to the upper section 70. The two walls 78 are configured to fit into respective correspondingly positioned, sized and shaped slots 80 of an upper disc member 81 in the reel 68.

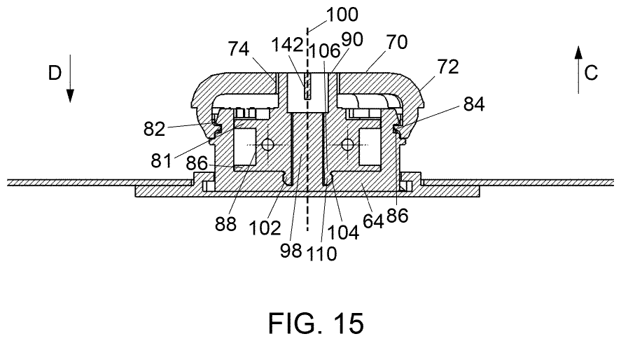

A plurality of curved and spaced apart resiliently deformable clip members 82 extend from the distal end of the sidewall 72, each of which includes an inwardly facing annular protrusion 84 configured to engage a corresponding a recess 86 in the main body 64 to couple the lid 62 to the main body 64. When the lid 62 is coupled to the main body 64 by the clip members 82 the lid 62 is in principle able to rotate around a central axis 100 (see FIG. 15) relative to the main body 64 but relative axial movement along the central axis 100 is prevented by the annular protrusion 84 being engaged the recess 86 in the main body 64.

The reel 68 comprises the upper disc member 81 mentioned above and a lower disc member 86 of generally similar circumference to the upper disc member 81. The upper disc member 81 and the lower disc member 86 are spaced apart by a generally cylindrical spool member 88 that has a smaller circumference than the upper disc member 81 and the lower disc member 86. A smaller circumference generally cylindrical mode selector member 90 extends from the centre of the upper surface of the upper disc member 81, in a region between the slots 80. The mode selector member 90 is sized and shaped to fit through the aperture 74 in the lid 62 when the reel 68 is positioned within a generally cylindrical cavity 92 of the main body 64 and the lid 62 is coupled to the main body 64.

The cylindrical cavity 92 of the main body 64 has a disc shaped base 94 and a generally circular wall 96 extending generally perpendicularly from the periphery of the base 94. A generally cylindrical shaft 98 extends form the centre of the upper side of the base 94 and which is positioned, sized and shaped to fit within a corresponding generally cylindrical recess 100 of the reel 68 that extends through the centres of the lower disc member 86, the spool member 88 and the upper disc member 81. The reel 86 can in principle rotate relative to the shaft 98 about central axis 100.

the upper surface of the base 94 includes an annular recess 102 around the outside of the shaft 98. The recess 102 includes at least one convex wall 104 so that the entrance 106 of the recess 102 is narrower than the widest part of the recess 102 (measured perpendicularly to the axis 100). The underside of the lower disc member 86 of the reel 68 includes an annular flange 110 that includes at least one convex wall 112. The widest point of the flange 110 fits within the recess 102 but is wider than the entrance 106 of the recess 102. One or both of the entrance 106 of the recess 102 of the main body 64 and the annular flange 110 of the reel 68 are resiliently deformable, so that the annular flange 110 can be pushed past the entrance 106 of the recess 102 to clip the annular flange 110 into the recess 102 so as to resist relative movement between the main body 64 and the reel 68 axially along the central axis 100, and so the lower disc member 86 abuts the base 94.

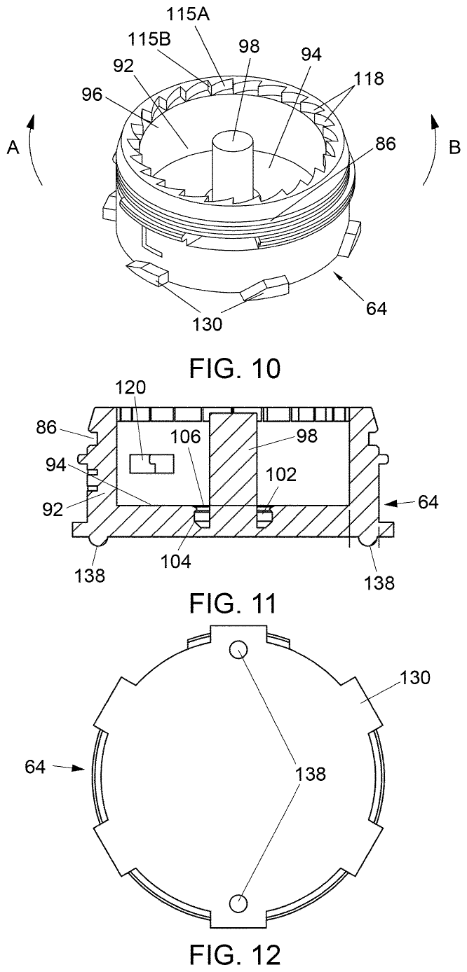

The upper disc member 81 of the reel 68 includes two resiliently deformable pawls 114, each having a generally triangular head 116 at its distal end. The heads 116 are sized and positioned so that, when the reel 68 is in the main body 64 in the engaged mode, each of the heads 116 engages one of the plurality of cut-out teeth 118 formed at the top of and around the circumference of the generally circular wall 96, forming a ratchet system that only allows the reel 68 to turn in one (tightening) direction (“A” in FIGS. 10, 16 and 21) within the main body 64. When the reel 68 turns in the tightening direction, the inclined wall 115a of the currently engaged tooth 118 deforms each pawl 114 inwardly until the next tooth is reached, whereafter the pawl 114 resiles and engages the next tooth. If an attempt is made to turn the reel 68 in the opposite (loosening) direction (“B” in FIGS. 10, 16 and 22), the radially extending wall 115b of the currently engaged tooth 118 presses against the flat edge of the head 116 and such movement is prevented.

The turning of the reel 68 can be performed by turning the lid 62. The lid 62 and the reel 68 rotate together due to the engagement of the walls 78 of the lid 62 with the corresponding slots 80 of the upper disk member 81 of the reel 68.

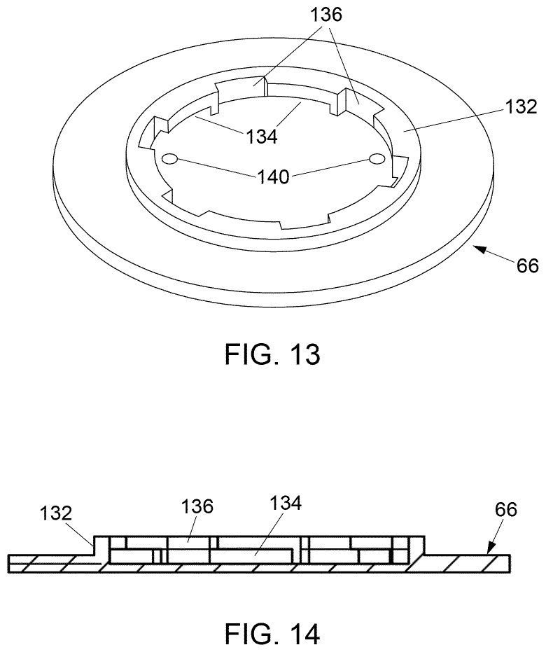

The main body 64 has a plurality of (e.g. six) spaced apart wedges 130 around its outer circumference near to the bottom of the wall 96. As shown in FIG. 13, the base 66 has a circular formation 132 forming a plurality of (e. g. six) slots 134 that are positioned, sized and shaped for receiving the wedges 130 of the main body 64. A recess 136 is provided in the circular formation 132 at the entrance to each of the slots 134. The recesses 136 are sized and shaped for the wedges 130 to pass through when the main body 64 and the base 66 are brought together in the axial direction 100. Relative rotation between the main body 64 and the base 66 then slides the wedges 130 into the slots 134. One or more small dimples 138 is located on the underside of the base 94 then aligns with corresponding recesses 140 on the base 66 to lock the main body 64 into the base 66 and preventing it from turning loose.

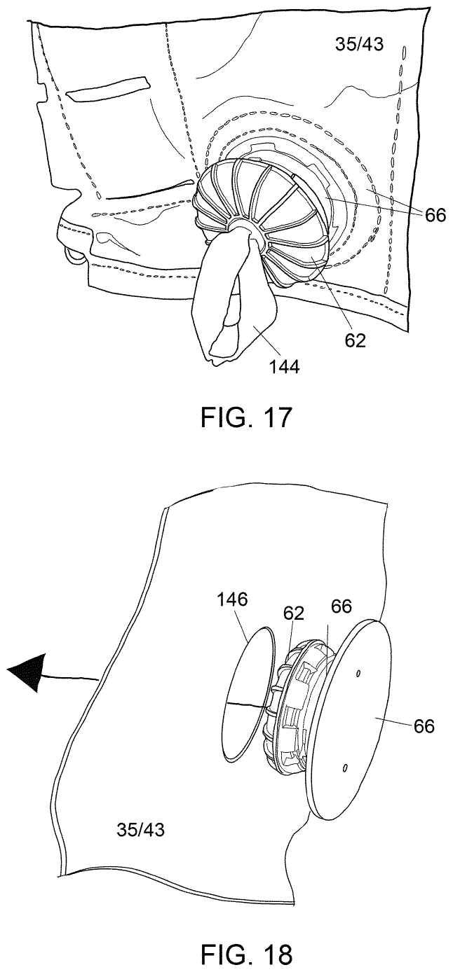

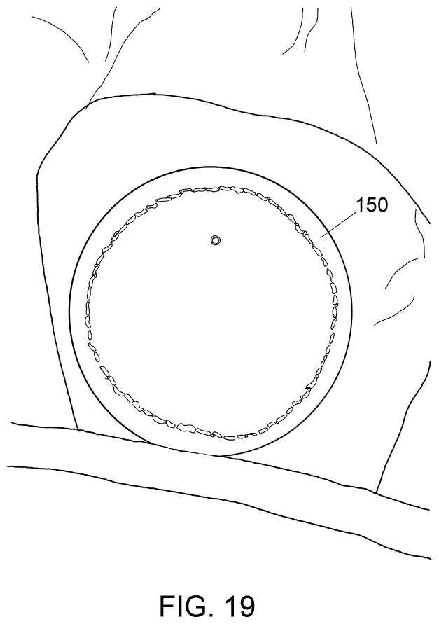

As shown in FIG. 17 The base 66 can be sewn into (or otherwise attached to) the aircrew ensemble (the upper suit portion 20 or the lower suit portion 21) with the main body 64 and the attached lid 62 passing through an aperture 146 (see FIG. 18) in the outer layer 35/43 for the user to be able to access with ease. The aircrew ensemble (the upper suit portion 20 or the lower suit portion 21) may be reinforced in the region 150 around where the base 66 is attached, as shown in FIG. 19.

A lace from the lacings 38 or 44 enters the main body 64 through a slot 120 in the generally circular wall 96, then passes through a first linear passage 122a in the spool member 88 in a first direction, then passes around the curved surface of the spool member 88 and through a second linear passage 122b in the spool member 88 in a second, opposite direction, and finally exits through the slot 120. When connected in this way, the turning of the reel 68 in the tightening direction draws the lace into the main body 64 so that it is wound around the spool member 88 of the reel 68—to thereby tighten the lacings 38 or 44. The lower disc member 86 includes one or more peripheral recesses 140 to allow the lace to pass through when pushing the reel 68 onto the main body 64 in the axial direction 100.

The lacings 38 or 44 can be loosened by pulling the reel 68 upwardly in the direction of arrow “C” shown in FIG. 15. The annular flange 110 of the reel 68 is then pulled out from its snap fit with the recess 102 in the main body 64 and lifting the heads 116 of the pawls 114 above and clear of teeth 118 formed at the top of wall 96 of the main body 64, thereby disengaging the ratchet system and allowing the reel 68 to rotate freely within the main body 66 in either direction.

The mode selector member 90 of the reel 68 is provided with a central bar 142 around which a strip of material or webbing 144 can be looped to facilitate manual upward movement of the reel 68 within the main body, by pulling the strip of material or webbing 144 to move the garment adjustment system 60 from the engaged mode to the disengaged mode.

The garment adjustment system 60 can be moved from the disengaged mode to the engaged mode by pushing the mode selector member 90 downwardly in the direction of arrow “D” shown in FIG. 15. The annular flange 110 of the reel 68 pushed into a snap fit with the recess 102 in the main body 64 and aligning the heads 116 of the pawls 114 with the teeth 118 formed at the top of wall 96 of the main body 64, thereby engaging the ratchet system.

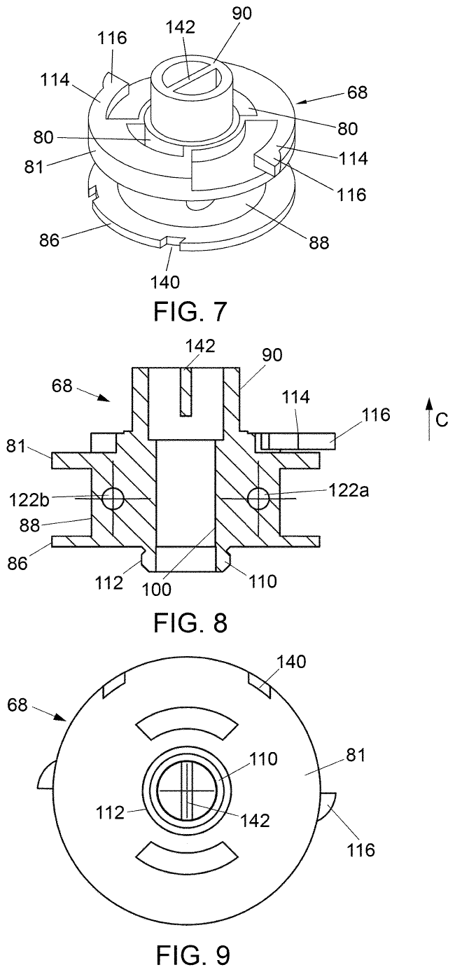

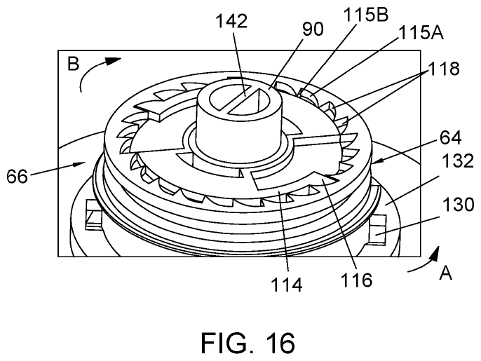

There may be one or more garment adjustment systems 60 on each side of the aircrew ensemble. For example, there may be two lacing systems per garment—one on the left and one on the right. The garment adjustment system 60 on the left may be configured to rotate anticlockwise to pull the lace/cord that is laced to the garment into the main body 64 (i.e. the tightening direction is anticlockwise). The garment adjustment system 60 on the right may be configured to rotate clockwise to pull the lace/cord that is laced to the garment into the main body 64 (i.e. the tightening direction is clockwise). The tightening direction (anticlockwise or clockwise) is determined by the arrangement of the cut-out teeth 118 formed at the top of the wall 96 of the main body 64 and the pawls 114 of the reel 68. FIGS. 7 and 10 show the reel 68 and main body 64 configured for an anticlockwise tightening direction. FIG. 16 shows the reel 68 and main body 64 configured for a clockwise tightening direction.

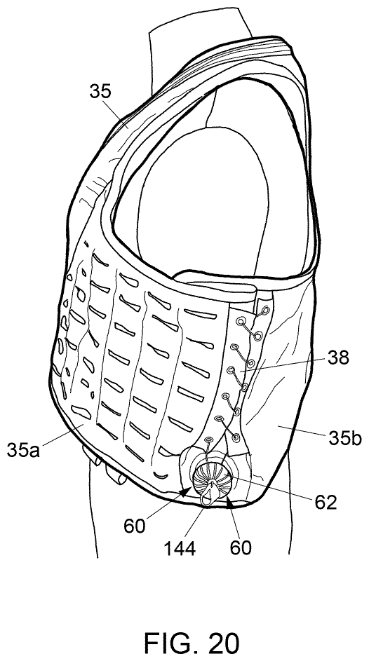

FIG. 20 shows a side view of an upper suit portion 20. The outer layer 35 front and rear portions 35a, 35b that are interconnected by a row of upper portion side lacing 38 (formed e. g. by one or more cords of ropes) located at the left side of the outer layer 35 to allow the circumferential length of the jacket to be adjusted to the correct fit for a wearer by rotation of the garment adjustment system 60 lid 62 in the tightening direction, when the garment adjustment system 60 is in the engaged mode. The garment can be loosened by pulling the strip of material or webbing 144 to move the garment adjustment system 60 from the engaged mode to the disengaged mode, as described above.

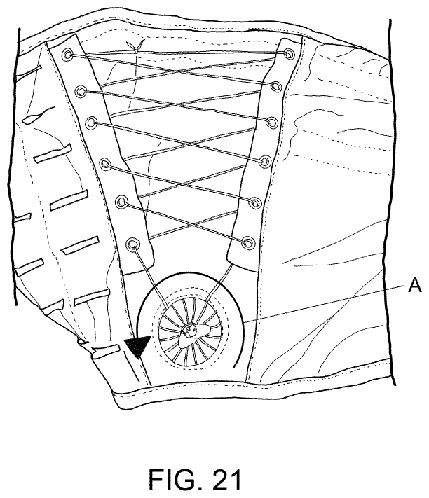

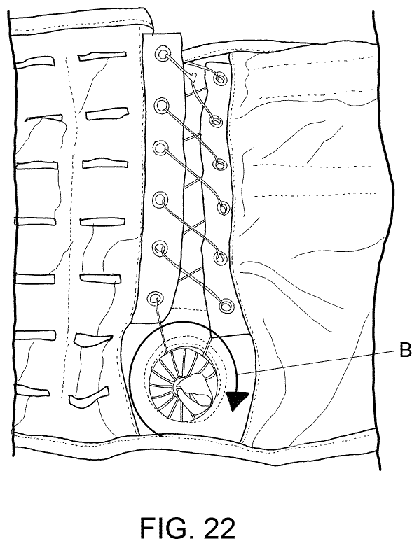

FIG. 21 shows a partial side view of the upper suit portion 20 of FIG. 20. In this Figure the upper suit portion 20 is loosened and the garment adjustment System 60 is in the disengaged mode. This allows rotation of the lid 62 in the clockwise (loosening direction “B”). The engagement mode is entered by pushing the lid 62 inwardly, so that the ratchet system engages, as described above. Anticlockwise rotation of the lid 62 in the tightening direction “A” them causes progressive tightening of the upper suit portion 20 as each successive tooth 118 of the main body portion 64 is engaged by the pawls 114 of the reel 68. This draws the lace/cord into the garment adjustment system 60 as it winds around the spool member 88—so the upper suit portion 20 is tightened, as shown in FIG. 22.

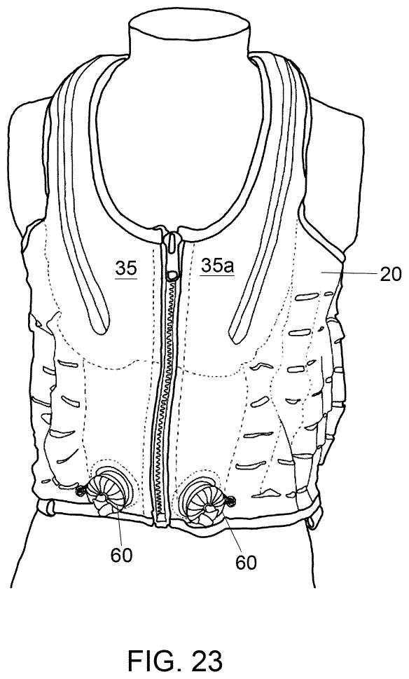

FIG. 23 shows an alternative arrangement in which lace/cords are provided under the outer layer 35 of the upper suit portion 20 and is tightened by respective garment adjustment systems 60 at the front of the upper suit portion 20 on the left- and right-hand sides. The lace/cords are mounted to the inside of the outer layer 35 such that operation of the garment adjustment system 60 tightens or loosens the upper suit portion 20 against the wearer's body. The location of the lace/cords is shown by the lines 180 in FIGS. 24, 25, 26 and 27.

One lace/cord is mounted to the inside of the outer layer 35 and extends from one of the garment adjustment systems 60 to the other and passes around the waist region of the upper suit portion (at waist of the wearer, in use). Another lace/cord is mounted to the inside of the outer layer 35 and extends from one of the garment adjustment systems 60 to the other and passes over a chest region of the upper suit portion 20 (at chest of the wearer, in use) and around a back portion of the upper suit portion 20 (at below the shoulder blades of the wearer, in use). Alternatively, a single lace/cord may extend around the waist region and the chest/back regions.

The arrangement of the garment adjustment system 60 and the lace/cord in FIG. 1 (garment adjustment system 60a) and FIGS. 20 to 27 allows the tightness of the upper suit portion 20 to be adjusted at the chest and waist simultaneously by the operation of a single garment adjustment system 60.

The garment adjustment system 60 may be used with a variety of garments, including those without the inflatable anti-G bladders described above. The garment adjustment system 60 may be useful in any application where it is desirable to adjust the fit/tightness of a garment. For example. The garment adjustment system 60 allows an outer garment to be adjusted to compensate for different thicknesses of undergarments-so that the fit/tightness of the outer garment to the wearer is the same irrespective of the thicknesses of undergarments.

A garment may include on or more internal pockets or other mounting arrangement for locating one or more armour panels (or generally protective or supportive members) in relation to the body of the wearer-e.g. to protect the wearer from injury from bullets. For example, an armour panel may be located in the position marked with the dashed lines 170 in FIG. 1. The armour panel(s) may be rigid. The armour panel(s) may be removable. It is important to properly locate the armour panel(s) so they protect the most vulnerable parts of the wearer. The garment adjustment system 60 allows the aircrew ensemble to be fitted appropriately to the wearer when the armour panel(s) are present, so the armour panel(s) are correctly located and held firmly in place against the body of the wearer. If (or when) the armour panels are removed, the garment adjustment system 60 allows the aircrew ensemble to be fitted appropriately to the wearer to compensate for the absence of the armour panel(s) so, for example, the aircrew ensemble (or other garment) can be tightened to compensate for the removal of the armour panel(s) so that the same fit of the ensemble to wearer can maintained whether the armour is present or absent.

The garment adjustment system 60 may be used with a survival (immersion) suit. For example, the garment adjustment system 60 may tighten the suit around the wearer's legs to expel air from the area, which might otherwise affect the self-righting or Face Plane Angle properties of the suit.

As an alternative to the garment adjustment system 60 being tightened by manual rotation of the lid 62, the tightening operation may be performed by a motor that (directly or indirectly) rotates the reel 68. The motor may control tightening of the garment and/or loosening of the garment. The ratchet arrangement may be omitted if the motor is configured to control the tightening/untightening to provide the desired fit to the wearer. The motor may be controlled remotely e.g. by a wired or wireless connection. The motor may be configured to automatically sense the appropriate fit/tightness of the garment and to control rotation of the reel 68 to fix the garment at the desired fit/tightness.

1. A garment adjustment system for adjusting the fit of a garment to a wearer, the system including a lacing arrangement for attachment to the garment and a reel assembly, the reel assembly and the lacing arrangement being configured to cooperate to adjust the fit of the garment to the wearer.

2. The system of claim 1, configured to adjust the fit of the garment to the torso of the wearer.

3. The system of claim 1, configured to adjust the fit of the garment to the legs of the wearer.

4. The system of claim 1, wherein the reel assembly includes a ratchet configured to allow the progressive tightening of the fit of the garment to the wearer

5. The system of claim 4, wherein the reel assembly includes a release arrangement configured to release the ratchet to loosen the fit of the garment

6. The system of claim 5, wherein the release arrangement includes a grip member such that manual pulling of the grip member allows the lacing arrangement to loosen the fit of the garment.

7. The system of claim 6, wherein the grip member comprises a-at least one of a flexible strip of material or webbing.

8. The system of claim 1, wherein the lacing arrangement includes at least one of a cord, a rope or a lace.

9. The system of claim 1, wherein the reel assembly is motorised to automatically adjust the fit of a garment to the wearer.

10. A garment including the garment adjustment system of claim 1.

11. The garment of claim 10, wherein the garment includes a mounting for an armour member to protect the wearer, the garment adjustment system being configured to adjust the fit of the garment to the wearer to be appropriate when the armour member is present in the mounting and absent from the mounting.

12. A garment including a garment adjustment system for adjusting the fit of a garment to a wearer, the system including a lacing arrangement attached to the garment and a reel assembly, the reel assembly and the lacing arrangement being configured to cooperate to adjust the fit of the garment to the wearer, wherein the garment includes a mounting for a removable armour member to protect the wearer, the garment adjustment system being configured to adjust the fit of the garment to the wearer to be appropriate when the armour member is present in the mounting and absent from the mounting.

13. The garment of claim 10, wherein the lacing arrangement is attached to the garment such that the reel assembly and the lacing arrangement are configured to adjust the fit of the garment to the waist and chest of the wearer simultaneously.

14. The garment of claim 13, wherein the lacing arrangement passes around a waist region of the garment, passes over a chest region of the garment and around a back portion of the garment.

15. The garment of claim 10, including a plurality of the garment adjustment systems.

16. The garment of claim 10, wherein the garment is an aircrew protection garment.
